(19) United States
(12) Patent Application Publication
(10) Pub. No.: US 2026/0210729 A1
(43) Pub. Date: Jul. 23, 2026

(54) COLLABORATIVE NAVIGATION

(71) Applicant: Ford Global Technologies, LLC, Dearborn, MI (US)

(72) Inventors: Keith Weston, Canton, MI (US); John Robert Van Wiemeersch, Novi, MI (US); Brendan F. Diamond, Naples, FL (US)

(21) Appl. No.: 19/035,157

(22) Filed: Jan. 23, 2025

(51) Int. Cl. G01C 21/34; G01C 21/36

(52) U.S. Cl. CPC G01C 21/3484; G01C 21/3492; G01C 21/3676

(57) ABSTRACT

A plurality of routes, from an origin to a destination, are received from each of a plurality of navigation applications executed by the one or more controllers and/or by one or more mobile devices in communication with the vehicle over at least one connectivity interface. A recommended route is identified from each of the plurality of navigation applications to define a set of recommended routes. The recommended routes are aggregated to determine discrepancies between the recommended routes. Responsive to the recommended routes being in agreement, the recommended routes are utilized as an optimized route for the vehicle. Responsive to the recommended routes not being in agreement, the discrepancies are illustrated in an HMI of the vehicle.

### TECHNICAL FIELD

Aspects of the disclosure generally relate to navigation and route planning.

### BACKGROUND

Navigation systems exist in many forms. Some navigation systems are integrated in a vehicle, while others are provided via a mobile device. Different navigation systems may have different features and/or may provide different guidance to a user.

### SUMMARY

In one or more illustrative examples, a vehicle for determining optimal routes includes one or more controllers providing at least one connectivity interface, the at least one connectivity interface being configured to connect with a plurality of navigation applications executed by the one or more controllers and/or by one or more mobile devices; and a navigation engine executed by at least one of the one or more controllers, the navigation engine configured to receive a plurality of routes, from an origin to a destination, from each of the plurality of navigation applications, including to identify a recommended route from each of the plurality of navigation applications to define a set of recommended routes, aggregate the recommended routes to determine discrepancies between the recommended routes, responsive to the recommended routes being in agreement, utilize the recommended routes as an optimized route for the vehicle, and responsive to the recommended routes not being in agreement, illustrate the discrepancies in a human-machine interface (HMI) of the vehicle.

In one or more illustrative examples, the at least one connectivity interface includes a plurality of connectivity interfaces, and the one or more controllers providing the plurality of connectivity interfaces includes at least two of a telematics control unit (TCU), a vehicle entertainment controller, and a keyless entry controller.

In one or more illustrative examples, a first navigation application of the plurality of navigation applications is executed by a first mobile device of the one or more mobile devices, and a second navigation application of the plurality of navigation applications is executed by a second mobile device of the one or more mobile devices.

In one or more illustrative examples, the plurality of navigation applications includes multiple navigation applications executed by one of the one or more mobile devices.

In one or more illustrative examples, a first navigation application of the plurality of navigation applications is executed by the one or more controllers, and a second navigation application of the plurality of navigation applications is executed by a first mobile device of the one or more mobile devices.

In one or more illustrative examples, the navigation engine is further configured to retrieve weather conditions associated with the plurality of routes using one or more weather applications executed by the one or more mobile devices; and optimize the recommended routes based on user-defined weather preferences and the retrieved weather conditions.

In one or more illustrative examples, the navigation engine determines the recommended routes as being in agreement responsive to all of the recommended routes having a variation within a predefined threshold of time.

In one or more illustrative examples, the navigation engine determines the recommended routes as being in agreement responsive to a majority of the recommended routes being in agreement.

In one or more illustrative examples, the navigation engine is further configured to receive a first traffic-related route condition from a first navigation application of the plurality of navigation applications; receive a second traffic-related route condition from a second navigation application of the plurality of navigation applications; utilize a machine-learning model to determine whether the first and second traffic-related route conditions corroborate an issue along the optimized route; responsive to the first and second traffic-related route conditions indicating the corroborated issue, illustrate the corroborated issue in the HMI as being identified by the first and second navigation applications; and otherwise, illustrate the first and second traffic-related route conditions as separate issues in the HMI.

In one or more illustrative examples, the navigation engine is further configured to send a message to listening crowd-sourced data devices to request crowd-sourced data; and receive the crowd-sourced data from the crowd-sourced data devices to corroborate and/or augment the traffic-related route conditions from the navigation applications.

In one or more illustrative examples, a method for determining optimal routes for a vehicle includes receiving a plurality of routes, from an origin to a destination, from each of a plurality of navigation applications executed by the one or more controllers and/or by one or more mobile devices in communication with the vehicle over at least one connectivity interface; identifying a recommended route from each of the plurality of navigation applications to define a set of recommended routes; aggregating the recommended routes to determine discrepancies between the recommended routes; responsive to the recommended routes being in agreement, utilizing the recommended routes as an optimized route for the vehicle; and responsive to the recommended routes not being in agreement, illustrating the discrepancies in an HMI of the vehicle.

In one or more illustrative examples, the method further includes providing, a plurality of connectivity interfaces using at least two of a TCU of the vehicle, a vehicle entertainment controller of the vehicle, and a keyless entry controller of the vehicle, wherein a first navigation application of the plurality of navigation applications is executed by a first mobile device of the one or more mobile devices, and wherein a second navigation application of the plurality of navigation applications is executed by a second mobile device of the one or more mobile devices.

In one or more illustrative examples, the method further includes retrieving weather conditions associated with the plurality of routes using one or more weather applications executed by the one or more mobile devices; and optimizing the recommended routes based on user-defined weather preferences and the retrieved weather conditions.

In one or more illustrative examples, the method further includes one of determining the recommended routes as being in agreement responsive to all of the recommended routes having a variation within a predefined threshold of time; or determining the recommended routes as being in agreement responsive to a majority of the recommended routes being in agreement.

In one or more illustrative examples, the method further includes receiving a first traffic-related route condition from a first navigation application of the plurality of navigation applications; receiving a second traffic-related route condition from a second navigation application of the plurality of navigation applications; utilizing a machine-learning model to determine whether the first and second traffic-related route conditions corroborate an issue along the optimized route; responsive to the first and second traffic-related route conditions indicating the corroborated issue, illustrating the corroborated issue in the HMI as being identified by the first and second navigation applications; and otherwise, illustrating the first and second traffic-related route conditions as separate issues in the HMI.

In one or more illustrative examples, the method further includes sending a message to listening crowd-sourced data devices to request crowd-sourced data; and receiving the crowd-sourced data from the crowd-sourced data devices to corroborate and/or augment the traffic-related route conditions from the navigation applications.

In one or more illustrative examples, a non-transitory computer-readable medium includes instructions for determining optimal routes for a vehicle that, when executed by one or more controllers of the vehicle, cause the vehicle to perform operations including to provide a plurality of connectivity interfaces using at least two of a TCU of the vehicle, a vehicle entertainment controller of the vehicle, and a keyless entry controller of the vehicle, receive a plurality of routes, from an origin to a destination, from each of a plurality of navigation applications executed by the one or more controllers and/or by a plurality of mobile devices in communication with the vehicle over the plurality of connectivity interfaces; identify a recommended route from each of the plurality of navigation applications to define a set of recommended routes; aggregate the recommended routes to determine discrepancies between the recommended routes; responsive to the recommended routes being in agreement, utilize the recommended routes as an optimized route for the vehicle; and responsive to the recommended routes not being in agreement, illustrate the discrepancies in a HMI of the vehicle.

In one or more illustrative examples, the non-transitory computer-readable medium further includes instructions that, when executed by the one or more controllers of the vehicle, cause the vehicle to perform operations including to retrieve weather conditions associated with the plurality of routes using one or more weather applications executed by the plurality of mobile devices; and optimize the recommended routes based on user-defined weather preferences and the retrieved weather conditions.

In one or more illustrative examples, the non-transitory computer-readable medium further includes instructions that, when executed by the one or more controllers of the vehicle, cause the vehicle to perform operations including to determine the recommended routes as being in agreement responsive to at least a majority of the recommended routes being in agreement.

In one or more illustrative examples, the non-transitory computer-readable medium further includes instructions that, when executed by the one or more controllers of the vehicle, cause the vehicle to perform operations including to receive a first traffic-related route condition from a first navigation application of the plurality of navigation applications; receive a second traffic-related route condition from a second navigation application of the plurality of navigation applications; utilize a machine-learning model to determine whether the first and second traffic-related route conditions corroborate an issue along the optimized route; responsive to the first and second traffic-related route conditions indicating the corroborated issue, illustrate the corroborated issue in the HMI as being identified by the first and second navigation applications; and otherwise, illustrate the first and second traffic-related route conditions as separate issues in the HMI.

In one or more illustrative examples, the non-transitory computer-readable medium further includes instructions that, when executed by the one or more controllers of the vehicle, cause the vehicle to perform operations including to send a message to listening crowd-sourced data devices to request crowd-sourced data; and receive the crowd-sourced data from the crowd-sourced data devices to corroborate and/or augment the traffic-related route conditions from the navigation applications.

### BRIEF DESCRIPTION OF THE DRAWINGS

FIG. 1 illustrates an example navigation system for determining optimal routing for vehicles;

FIG. 2A illustrates an example navigation application overlay of a plurality of routes between an origin and a destination as determined by a first navigation application;

FIG. 2B illustrates another example navigation application overlay of a plurality of routes between the origin and the destination as determined by a second navigation application;

FIG. 2C illustrates yet another navigation application overlay of a plurality of routes between the origin and the destination as determined by a third navigation application;

FIG. 2D illustrates an example of a human machine interface displaying the navigation application warning image for traffic related issues;

FIG. 2E illustrates an example of the human machine interface displaying multiple images and warnings for traffic related issues from the first navigation application, the second navigation application, the third navigation application and a weather alert from a weather-related application;

FIG. 3 illustrates an example process for using the navigation engine in communication with a plurality of navigation applications and/or weather applications to provide an optimized navigation route to a destination;

FIG. 4 illustrates an example process for using the navigation engine in communication with a plurality of navigation applications and/or weather applications to provide notifications of traffic related issues and/or weather-related issues;

FIG. 5 shows an illustrative example of the vehicle utilizing crowd-sourced data to corroborate and/or augment the operation of the navigation engine; and

FIG. 6 illustrates an example computing device for implementing the navigation system for determining optimal routing for vehicles.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Different navigation applications may provide different recommended routes to a destination or the same routes with different time estimates. When time to destination and/or route recommendations vary, users may question the accuracy of the recommended routes. Moreover, different vehicle occupants may have different requirements as to weather. For example, a user hauling dirt or mulch may not want to drive in the rain. In another example, an adventurer may prefer a route that has snowy conditions to drive in the snow.

An improved vehicle navigation approach may be based on use of routes from multiple navigation applications, and optionally with consideration of real time weather. The approach may allow the occupant to select a route with greater accuracy and with consideration of the occupant's weather preferences.

The approach may utilize multiple navigation apps simultaneously. In an example, one mobile device may execute multiple mapping programs at the same time (e.g., Waze, Apple Maps, Google Maps) along with one or more weather tracking programs at the same time (e.g., The Weather Channel, Weather Underground, AccuWeather). In another example, multiple mobile devices may be connected to the vehicle, with each mobile device running one or more of the different navigation applications. Vehicle occupants may also stream music from one phone, navigation from another, and weather apps from another, e.g., where different occupant devices might be responsible for these different tasks.

These multiple connections may be supported by the multiple BLUETOOTH Low Energy (BLE) transceivers in the vehicle. For instance, a first mobile device may connect to a connectivity interface of the vehicle entertainment system, a second mobile device may connect to a connectivity interface of the telematics control unit (TCU), and a third mobile device may connect to a connectivity interface of the connected car BLUETOOTH access controller.

A vehicle occupant (also referred to herein as user) may define a data source mapping of the combination of weather and navigation applications for the vehicle to employ. Responsive to the applications providing a consistent recommendation, the vehicle may use that recommendation. Responsive to the applications providing disparate results, the vehicle may offer majority vote or intervention to the vehicle occupant to decide.

If the applications disagree and the vehicle occupant elects an intervention, the vehicle occupant may select a place to pull over to review the data. If autonomous operation is available, the vehicle may allow the user to review the information while moving or allow a passenger to review the data and pick which directions to follow.

The approach may also combine traffic-related and/or weather-related route conditions from the different applications to offer the occupant a unified interface of information. To avoid redundancy, Artificial intelligence (AI) techniques may be used to compare the information from different applications to determine if the applications are reporting the same or different issues. This may be beneficial because the various applications may express the same information in different ways.

Additionally, the architecture may utilize crowd-sourced data from various sources, such as other vehicles, bystander mobile devices, and/or vehicle cameras. To incentivize parties to use crowd-sourced data, the approach may offer rewards for route investigation and for providing alternative route suggestions. Further aspects of the disclosure are discussed in detail herein.

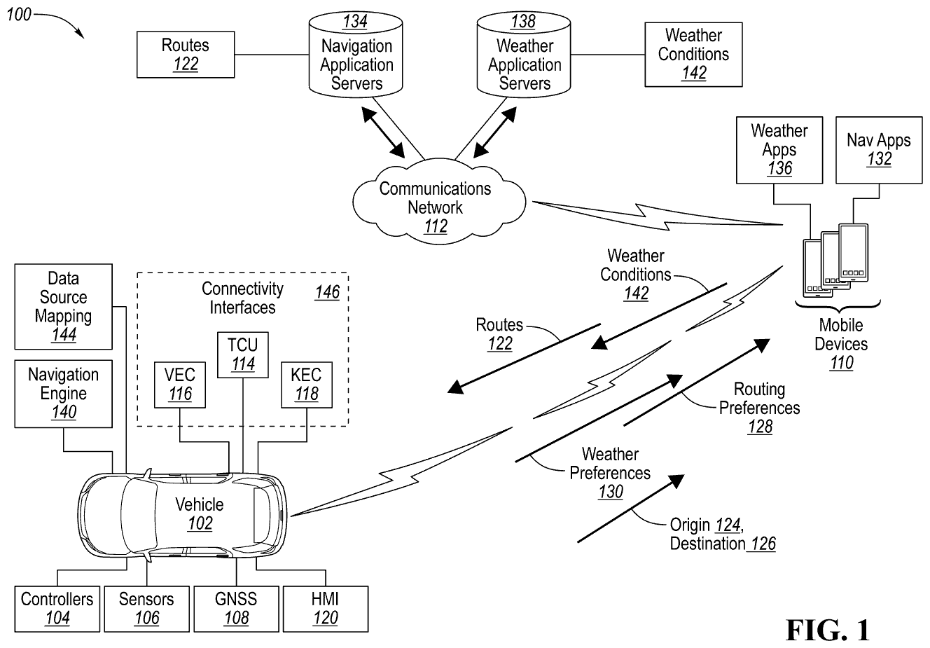

FIG. 1 illustrates an example navigation system 100 for determining optimal routing for a vehicle 102. The vehicle 102 may include various controllers 104. These controllers 104 may include a TCU 114 configured to communicate over a communications network 112, a vehicle entertainment controller (VEC) 116, a keyless entry controller (KEC) 118, and a global navigation satellite system (GNSS) controller 108. The vehicle 102 may include additional hardware, such as a human-machine interface (HMI) 120 and various sensors 106. In addition to the vehicle 102, the navigation system 100 also includes at least one mobile device 110 in communication with the vehicle 102. The mobile devices 110 may be configured to execute navigation applications 132 to determine routes 122 using navigation application servers 134, and may also be configured to execute weather applications 136 to determine a weather condition 142 from weather application servers 138. A navigation engine 140 may be executed by the controllers 104 of the vehicle 102 to perform the optimized routing discussed in detail herein. It should be noted that the navigation system 100 is only an example, and navigation systems 100 with more, fewer, or different components may be used.

The vehicle 102 may include a plurality of controllers 104 configured to perform and manage various vehicle 102 functions under the power of the vehicle battery and/or drivetrain. The vehicle controllers 104 may be discrete controllers 104. In other cases, the controllers 104 may share physical hardware, firmware, and/or software, such that the functionality from multiple controllers 104 may be integrated into a single controller 104, and that the functionality of various such controllers 104 may be distributed across a plurality of controllers 104. The controllers 104 may be configured to communicate with one another over one or more vehicle buses. The vehicle buses may be configured to provide an electrical interface between the components of the vehicle 102. As some non-limiting examples, the vehicle buses may include one or more of a controller area network (CAN), an Ethernet network, a media-oriented system transfer (MOST) network and a wireless communication network.

The sensors 106 may include various hardware of the vehicle 102 that is used to collect information about its surroundings and status. As some non-limiting examples, the sensors 106 may include one or more of cameras (e.g., advanced driver assistance system (ADAS) cameras), ultrasonic transceivers, radio detection and ranging (RADAR) systems, and/or light detection and ranging (LIDAR) systems.

The GNSS controller 108 may be configured to provide information indicative of the current location of the vehicle 102. In an example, the GNSS controller 108 may be responsible for receiving signals from a GNSS constellation of satellites. This may allow the GNSS controller 108 to receive time information as well as for determining a precise location of the vehicle 102. The location determined by the GNSS controller 108 may be used for various tasks such as navigation or other location-based services.

The mobile devices 110 may include mobile phones, tablet computers, laptop computers, and other portable electronic devices that may be carried by a user and configured for wireless communication over the communications network 112. The vehicle 102 may be configured to communicate with any of the at least one mobile devices 110 using various communication protocol, such as BLUETOOTH, ultra-wideband (UWB), Wi-Fi or others.

The communications network 112 may provide communications services, such as packet-switched network services (e.g., Internet access, voice over internet protocol (VoIP) communication services), to devices connected to the communications network 112. The communications network 112 may include one or more interconnected communication networks such as the Internet, a cable television distribution network, a satellite link network, a local area network, a vehicle to everything (V2X) network, a Dedicated Short-Range Communications (DSRC) network and a telephone network, as some non-limiting examples.

The TCU 114 is a controller 104 of the vehicle 102 that may be utilized for communication over the communications network 112. In an example, TCU 114 may be configured to provide network functionality to support telematics and/or self-driving services of the vehicle 102. The TCU 114 may include network hardware configured to facilitate communication between the vehicle 102 and other devices of the navigation system 100. For example, the TCU 114 may include or otherwise access a cellular modem configured to facilitate communication with the communications network 112. In some cases, the TCU 114 may also support connection to the mobile devices 110 as an additional or alternate communication channel between the vehicle 102 and other devices.

The vehicle entertainment controller 116 is a controller 104 that is configured to support voice command and BLUETOOTH interfaces with a plurality of mobile devices 110 (e.g., mobile devices 110A, 110B, 110C as shown), receive occupant input via various buttons or other controls, and provide navigation and weather information through the HMI 120. The vehicle entertainment controller 116 may also support connection to the mobile devices 110 as a communication channel between the vehicle 102 and other devices.

The KEC 118 is a controller 104 and/or other hardware configured to provide keyless entry and/or occupant sensing functionality to the vehicle 102. The KEC 118 may include a UWB transceiver, a BLUETOOTH or BLUETOOTH Low Energy Module (BLEM) transceiver, or other network adapter that allows for the tracking of locations and/or identities of the mobile devices 110. The KEC 118 may also support connection to the mobile devices 110 as a communication channel between the vehicle 102 and other devices.

The HMI 120 may be configured to provide an interface through which the vehicle 102 occupants may interact with the vehicle 102. The interface may include a controller 104, a touchscreen display, voice commands, and physical controls such as buttons and knobs. The HMI 120 may be configured to receive occupant input via the various buttons or other controls, as well as provide status information to an occupant, such as fuel level information, engine operating temperature information, and current location of the vehicle 102. For example, the HMI 120 may be configured to receive user input and display of various elements discussed in detail herein, such as a route 122, an origin 124, a destination 126, routing preferences 128, and weather preferences 130. The HMI 120 may be configured to provide the information to various displays within the vehicle 102, such as a center stack touchscreen, a gauge cluster screen, etc. The HMI 120 may accordingly allow the vehicle 102 occupants to access and control various systems such as navigation, entertainment and communication system, and climate control.

A route 122 refers to a path that may be traversed by the vehicle 102 from an origin 124 to a destination 126. The origin 124 refers to the start location for the route 122. In many examples, the origin 124 is a current location of the vehicle 102. In an example, the origin 124 may be determined by the vehicle 102 using the GNSS controller 108. In other examples, the vehicle 102 may need to travel to the origin 124.

The destination 126 refers to an end location for the route 122. The destination 126 may include an address, a latitude and longitude coordinates, an intersection, worksite address, recently visited location, meeting location in a calendar, or the like. In some examples, the destination 126 may be provided prior to the user entering the vehicle 102 using the mobile device 110. For example, the destination 126 may be provided via a user input to the mobile device 110 configured to communicate the destination 126 to the navigation engine 140 when mobile device 110 is in or near the vehicle 102. In other examples, the destination 126 may be entered into the HMI 120 once the user enters the vehicle 102. In still other examples, the destination 126 may be inferred from information such as the user's calendar and/or historical routing for various times of day or day of week.

The routing preferences 128 include information indicative of what factors are important to the occupants in determining the route 122 from the origin 124 to the destination 126. These routing preferences 128 may include aspects such as preferring a shortest route 122, preferring a fastest route 122, preferring to avoid highways, etc.

The weather preferences 130 include information indicative of what types of weather conditions 142 are preferred by the occupants of the vehicle 102. In some cases, weather may not be important to the occupants of the vehicle 102. In such cases, the weather preferences 130 may indicate that weather does not need to be taken into account in determining the route 122. In other cases, the weather preference 130 may indicate that the occupants prefer certain weather conditions 142 to be present or not present. For example, an occupant hauling cargo in an open trailer may prefer a lack of precipitation, while an occupant looking for adventure may prefer for it to be snowing. In addition to precipitation, the weather preferences 130 may include preference for other aspects of the weather such as temperature, wind, or humidity.

The routing preferences 128 and/or the weather preferences 130 may vary based on the type of the vehicle 102 and/or based on the task to be performed using the vehicle 102. In an example, in the case of the vehicle 102 being a convertible, the weather preferences 130 may prefer a sun or rain free weather event to make the drive more enjoyable. In another example, for an offroad vehicle 102, the weather preferences 130 may indicate to evade weather conditions 142 such as rain or snow for an offroad trail destination 126.

The navigation applications 132 refer to applications that are executed by the mobile devices 110 (and in some cases on one or more controllers 104 of the vehicle 102) to provide routes 122 to the vehicle 102. Some example navigation applications 132 include Waze, Apple Maps, and/or Google Maps. To facilitate the routing, in some examples, the navigation applications 132 communicate over the communications network 112 with navigation application servers 134 configured to determine the routes 122.

The weather applications 136 refer to applications that are executed by the mobile devices 110 to provide weather condition 142 information to the vehicle 102. Some example weather application 136 include The Weather Channel, Weather Underground, and AccuWeather. To facilitate the capture of weather conditions 142, the weather applications 136 may communicate over the communications network 112 with weather application servers 138.

The navigation engine 140 refers to a software application that is executed by the controllers 104 of the vehicle 102 to perform the route 122 planning discussed in detail herein. The navigation engine 140 may be configured to receive the origin 124, destination 126, routing preferences 128, and weather preferences 130 communicated to the navigation engine 140 for distribution to the one or more mobile device 110. In turn, the navigation engine 140 may utilize the one or more mobile devices 110 to seek out routes 122 using the various navigation application servers 134 and weather condition 142 using the weather application servers 138. This information may be returned to the navigation engine 140 for comparison, for display to the HMI 120, and for other processing as discussed herein.

The navigation engine 140 may be configured to utilize a data source mapping 144 to determine how to utilize multiple mobile devices 110, navigation applications 132, and/or weather application 136 for determining the optimized route 122. In an example, the data source mapping 144 may indicate that one of the mobile devices 110 may be used to concurrently execute navigation applications 132 and/or weather applications 136. In another example, the data source mapping 144 may indicate that multiple mobile devices 110 may concurrently connect to the vehicle 102, each running one or more of the different navigation applications 132, and/or weather applications 136. Vehicle occupants may also stream music from one mobile device 110, navigation from another one or more mobile devices 110, and weather from still other mobile devices 110, such that different mobile devices 110 are responsible for these different tasks. This mapping may be indicated in the data source mapping 144 as well. The data source mapping 144 may be configurable by the user using the HMI 120.

The data source mapping 144 may also specify which connectivity interfaces 146 of the vehicle 102 should connect with which mobile devices 110. As noted herein, connections to multiple mobile devices 110 may be supported using the wireless functionality of the TCU 114, VEC 116, and/or KEC 118 of the vehicle 102. For instance, the TCU 114 may support a connectivity interface 146 for communication with a single mobile device 110, the VEC 116 may support another connectivity interface 146 for communication with a different other mobile device 110, and the KEC 118 may include an array of antennas that may provide for a plurality of connectivity interfaces 146 to additional mobile devices 110. In another example, the TCU 114 and/or the VEC 116 may support a connectivity interface 146 using the internal modem of the vehicle 102. By reusing these existing connectivity interfaces 146, the vehicle 102 may be able to support connection to multiple mobile devices 110 without additional networking hardware. Moreover, by spreading the operation of the various navigation applications 132 and weather applications 136 across multiple devices, the system 100 may improve reliability and reduce delay in processing.

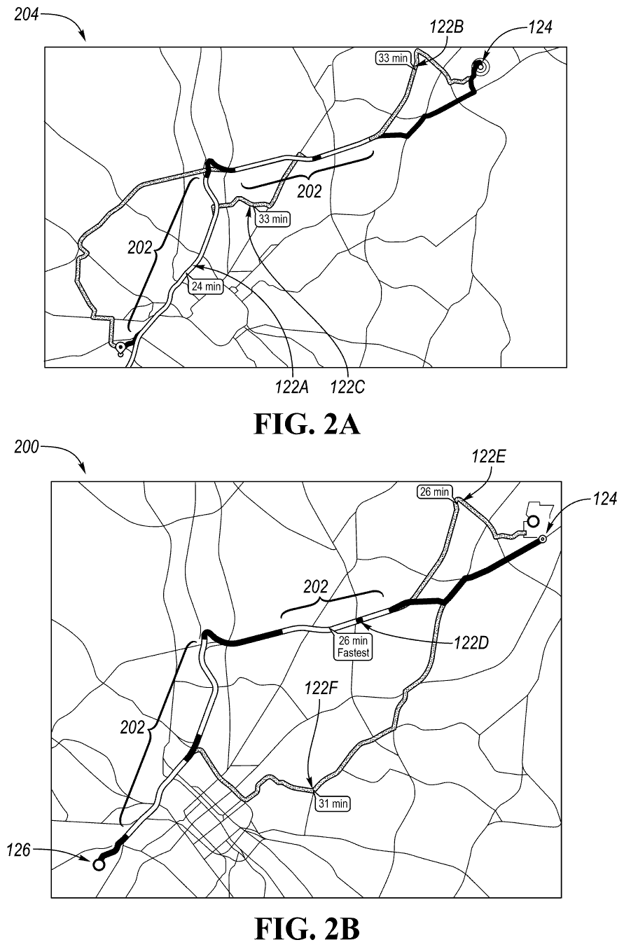

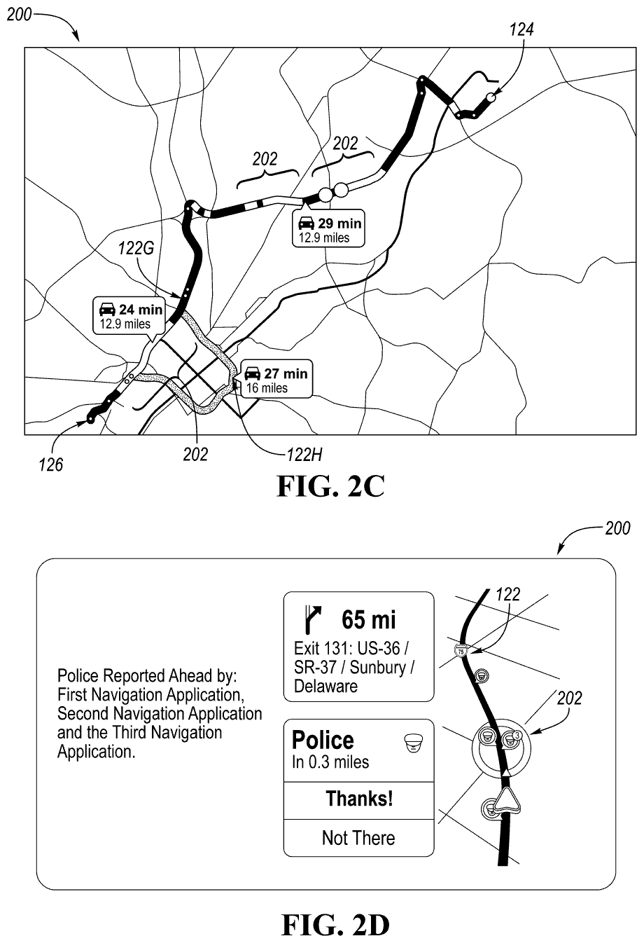

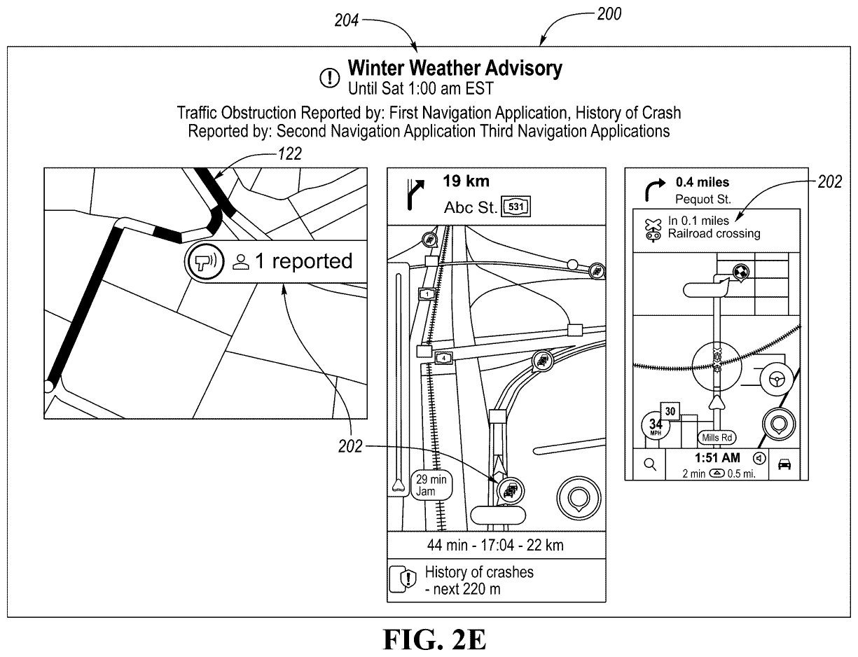

FIG. 2A illustrates an example navigation application overlay 200 of a plurality of routes 122 between an origin 124 and a destination 126 as determined by a first navigation application 132. The navigation application overlay 200 provides a plurality of varying routes 122 (here routes 122A, 122B, 122C) each beginning at the origin 124 and leading to the destination 126. The first route 122A has a predicted traversal time of 24 minutes to reach the destination 126, the second route 122B has a predicted traversal time of 33 minutes to reach the desired destination 126, and the third route 122C has a predicted traversal time of 33 minutes to reach the destination 126. The first navigation application 132 may also indicate one of the routes 122A-122C as being a recommended route 122 (here route 122A). These routes 122A-122C may be provided from a first connected navigation application server 134 using the first navigation application 132 and may be transferred to the navigation engine 140 for processing.

As shown, the routes 122 may include traffic-related route conditions 202. These may include, for example, areas where a slowdown occurs due to high traffic. These may also include, for example, areas where an incident has occurred along the road, and/or where a lane or lanes may be blocked.

The navigation engine 140 may be configured to interoperate with multiple navigation applications 132. As illustrated in FIGS. 2B and 2C, by way of example, a plurality of routes 122 may be recommended from additional navigation applications 132 in communication with additional navigation application servers 134. These different navigation applications 132 may provide similar or the same routes 122 and/or different routes 122. Moreover, the different navigation applications 132 may provide the same or similar routes 122 with different predicted traversal times.

FIG. 2B illustrates another navigation application overlay 200 having three varying routes 122 (here routes 122D, 122E, 122F) extending between the origin 124 and the destination 126. These routes 122D-122F may be provided from a second connected navigation application server 134 using the second navigation application 132 and may be transferred to the navigation engine 140 for processing. The fourth route 122D has a predicted traversal time of 26 minutes, the fifth route 122E has a predicted traversal time of 26 minutes, and the sixth route 122E has a predicted traversal time of 31 minutes. Additionally, the second navigation application 132 indicates related but somewhat different traffic-related route conditions 202 along the routes 122D, 122E, 122F, as compared to the routes 122A, 122B, 122C shown in FIG. 2A. The second navigation application 132 may also indicate one of the routes 122D-122F as being a recommended route 122 (here route 122D).

FIG. 2C illustrates yet another navigation application overlay 200 having two varying routes 122 (here routes 122G, 122H) extending between the origin 124 and the destination 126. These routes 122G-122H may be provided from the third connected navigation application server 134 using the third navigation application 132 and may be transferred to the navigation engine 140 for processing. The seventh route 122G has a predicted traversal time of 24 minutes, and the eighth route 122H has a predicted traversal time of 27 minutes. Additionally, the third navigation application 132 again indicates related but somewhat different traffic-related route conditions 202 along the routes 122G, 122H as compared to the routes 122A-F shown in FIGS. 2A-2B. The third navigation application 132 may also indicate one of the routes 122G-122H as being a recommended route 122 (here route 122G).

The routes 122A-122G communicated from the mobile devices 110 to the navigation engine 140 may be processed and aggregated by the navigation engine 140. Using the varying routes 122A-122G, the navigation engine 140 may determine a recommended route 122 for display to the vehicle HMI 120 and/or for navigation by the vehicle 102.

FIG. 2D illustrates an example of the HMI 120 displaying a navigation alert for a traffic-related route condition 202. In addition to aggregating the routes 122, the navigation engine 140 may also aggregate the reported traffic-related route conditions 202. The navigation engine 140 may display the aggregated reported traffic-related route conditions 202 to the navigation application overlay 200.

In some cases, the different navigation applications 132 may report the same or similar traffic-related route conditions 202. To address this, the navigation engine 140 may compare any reported traffic-related route conditions 202 displayed for each route 122 as provided by each navigation application server 134. To avoid redundancy in the aggregation, the navigation engine 140 may use AI techniques, such as a foundational generative machine learning model (e.g., Claude, ChatGPT, llama, etc.) to determine if the provided routes 122 all include the same or different traffic-related route conditions 202. In an example, the navigation engine 140 may provide the routes 122 to the model along with a prompt asking if the routes include the same or different traffic-related route conditions 202. The model may return a response with the answer. If the routes 122 are determined to include the same or related traffic-related route conditions 202, those traffic-related route conditions 202 may be combined and displayed as a single incident. The navigation engine 140 may illustrate the specific incident or incidents as well as the source (or in cases of a combination of related incidents, the sources) of the information.

As shown in FIG. 2D, a single aggregated traffic-related route condition 202 is reported on the HMI 120 as reported by multiple navigation applications 132. The traffic-related route condition 202 states that “Police reported ahead by the first navigation application, the second navigation application, and the third navigation application.” While not shown, when the traffic-related route conditions 202 are not the same, the navigation engine 140 may report the specific traffic-related route conditions 202 individually with each source.

FIG. 2E illustrates an example of the HMI 120 displaying multiple images and warnings for traffic-related route conditions 202 from the first navigation application 132, the second navigation application 132, the third navigation application 132, and weather-related route conditions 204 from a weather application 136. As shown, the traffic-related route condition 202 from the first navigation application 132, the second navigation application 132, and the third navigation application 132 are combined in a single report to the HMI 120 stating “Traffic Obstruction on roadside ahead reported by the first navigation application 132, History of Obstruction reported by second navigation application 132 and railroad reported by third navigation application 132.” Alternately, the HMI 120 system may also use speech generation to provide an audible alert to the user.

Additionally, a weather-related route condition 204 received from a weather application 136 is also displayed in the navigation application overlay 200 to the HMI 120. The weather-related route condition 204 displays a weather condition 142, the weather condition 142 being that there is a “Winter Weather Advisory until Sat. 1:00 am EST.”

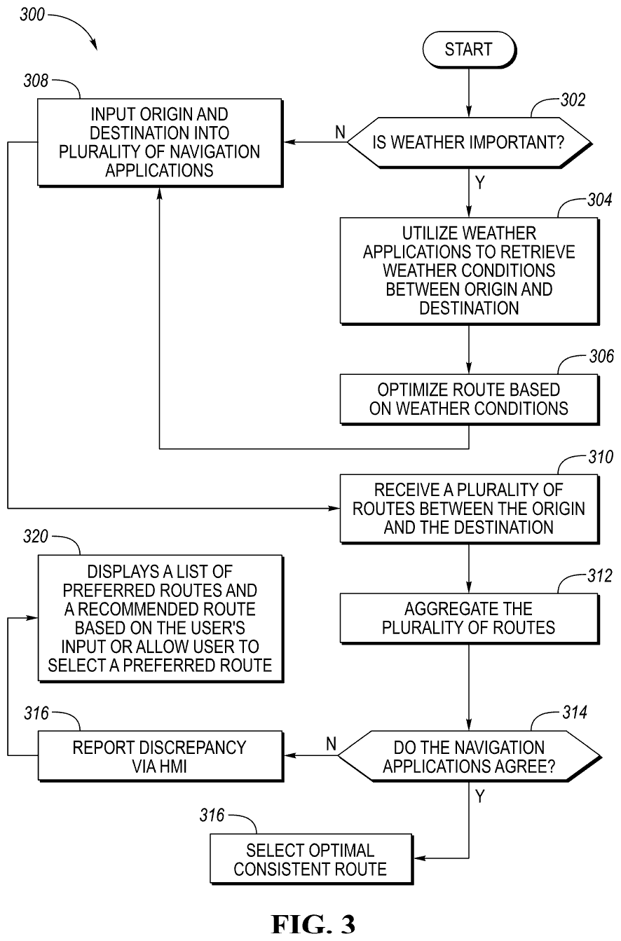

FIG. 3 illustrates an example process 300 for using the navigation engine 140 in communication with a plurality of navigation applications 132 and/or weather applications 136 to provide an optimized navigation route 122 to a destination 126. In one example, the process 300 may be performed by the navigation engine 140 in communication with the one or more mobile devices 110. The process 300 may begin with the origin 124 and destination 126 having been received or otherwise having been made available to the navigation engine 140.

At operation 302, the navigation engine 140 receives routing preferences 128 and/or weather preferences 130 for determining the route 122. This includes receiving an indication if weather is important. If weather is important, the navigation engine 140 retrieves the weather preferences 130 from storage of the vehicle 102, and/or receives the weather preferences 130 from the HMI 120 and control passes to operation 304. Otherwise, control proceeds to operation 308.

At operation 304, the navigation engine 140 utilizes the one or more mobile devices 110 to obtain weather conditions 142. In an example, the navigation engine 140 communicates with the one or more mobile devices 110 to request the weather conditions 142 from the weather applications 136 executed by the mobile devices 110. As a variation, one of the weather applications 136 may be executed by the vehicle 102 (e.g., via one or more of the controllers 104, such as the controllers providing the connectivity interfaces 146 or another controller 104). In turn, the weather applications 136 may communicate with one or more weather application servers 138 to obtain the weather conditions 142 between the origin 124 and the desired destination 126. In examples where multiple weather forecasts are received, the navigation engine 140 may compare the weather conditions 142 between the origin 124 and the destination 126 to determine if any differences in the received weather conditions 142 exist. In a simple example, the navigation engine 140 may average the temperatures that are received. In another example, the navigation engine 140 may defer to a weather application 136 deemed most reliable. In yet another example, the navigation engine 140 may use the worst weather condition reported. This aggregation allows the navigation engine 140 to provide a higher confidence that the weather conditions 142 are accurate.

At operation 306, the navigation engine 140 optimizes the route 122 based on the weather conditions 142. In some instances, the navigation engine 140 may add waypoints along the route 122 to cause the navigation applications 132 to avoid areas where the weather conditions 142 are inconsistent with the weather preferences 130. In other instances, the navigation engine 140 may identify areas that, were a route 122 to traverse, then that route 122 should be included in or excluded from a final recommended route 122. After operation 306, control proceeds to operation 308.

At operation 308, the navigation engine 140 provides the origin 124 and destination 126 to a plurality of navigation applications 132. In an example, the navigation engine 140 may utilize the one or more mobile devices 110 connected to the vehicle 102 to access the plurality of navigation applications 132. As a variation, one of the navigation applications 132 may be executed by the vehicle 102 (e.g., via one or more of the controllers 104, such as the controllers providing the connectivity interfaces 146 or another controller 104). Each of the plurality of navigation applications 132 may then obtain a plurality of routes 122 between the origin 124 and the desired destination 126, e.g., using their respective navigation application server 134. Examples of such routes 122 are shown in FIGS. 2A-2C.

At operation 310, the navigation engine 140 receives the routes 122 from the plurality of navigation applications 132. The routes 122 may include paths from the origin 124 to the destination 126 and in many cases estimated travel time. In addition, the routes 122 may include traffic-related route conditions 202 such as the presence of road blockages, police, etc., that may affect the flow of traffic between the origin 124 and the desired destination 126. The navigation application servers 134 may also provide their respective recommended route 122. In some examples, the navigation engine 140 may override the determination of the recommended routes 122 using the routing preferences 128 (e.g., choosing the fastest, shortest, avoiding highways, etc.).

As a variation on operations 306-310, in an alternate example the navigation engine 140 may utilize the weather conditions 142 obtained at operation 304 to determine the recommended routes 122. For example, the navigation engine 140 may filter the routes 122 received from the navigation applications 132 to exclude any routes 122 that do not meet the weather preferences 130 in view of the weather conditions 142. Based on the filtered routes 122, the navigation engine 140 may similarly identify a most recommended route 122 from the routes 122 that remain.

At operations 312, the navigation engine 140 aggregates the received routes 122. In an example, the navigation engine 140 machine learning optimization algorithm aggregates the recommended routes 122 to determine if there are any inconsistencies and to calculate the optimal navigation route 122 to travel and reach the desired destination 126.

At operation 314, the navigation engine 140 determines whether or not the routes 122 agree. In an example, if the recommended routes 122 agree, or if a majority of the recommended routes 122 agree, then the navigation engine 140 may choose that to be the optimized route 122.

As a more specific example, the routing preferences 128 may indicate that the occupant prefers a fastest route 122. In such a case, the plurality of navigation applications 132 may show the same route 122 as being fastest, but the specific time estimate may vary. To determine agreement, the navigation engine 140 may check whether the variation is within a predefined threshold, such as within a predefined number of minutes (e.g., five minutes) or within a predefined percentage of travel time (e.g., 10%). If so, the routes 122 may be considered to be reliable and consistent and the fastest route 122 may be selected as being the optimal route 122. If, however, there is variation in the timing beyond the predefined threshold, then the timing of the routes 122 may be considered to be uncertain and less reliable. In yet another possibility, if the navigation applications 132 indicate different routes 122 as being the fastest, then the routes 122 may also be indicated as being uncertain and less reliable.

Regardless of approach, if the routes 122 are considered to be consistent and/or reliable, control passes to operation 316. Otherwise, control passes to operation 318.

At operation 316, the navigation engine 140 selects the consistent route 122 as being the optimal route 122. In an example, the route 122 may be displayed to the HMI 120. In another example, the route 122 may be applied to autonomous or semi-autonomous functionality of the vehicle 102 to direct the vehicle 102 to the destination 126. After operation 318, the process 300 ends.

At operation 318, as the navigation applications 132 indicate a discrepancy in the routes 122, the discrepancy may be displayed to the HMI 120. The occupant may thus be able to use the HMI 120 to understand and address the discrepancy. In another example, the HMI 120 may offer an option that, when selected, allows the user to choose which of the routes 122 to take. In yet another example, the HMI 120 may offer an option for the user to intervene by pulling the vehicle 102 over to review the data. In still another example, if the vehicle 102 is operating in an autonomous mode (or can be transitioned to autonomous mode), the occupant may use the HMI 120 to review the routes 122 and choose which of the disparate routes 122 to follow.

In yet another example, the HMI 120 may provide a listing of the navigation applications 132. The HMI 120 may allow the occupant to define or adjust a priority order of which navigation applications 132 to rely on over which other navigation applications 132 in case of an inconsistency in the routes 122. For instance, the HMI 120 may allow the user to rank the navigation applications 132 in decreasing order of priority.

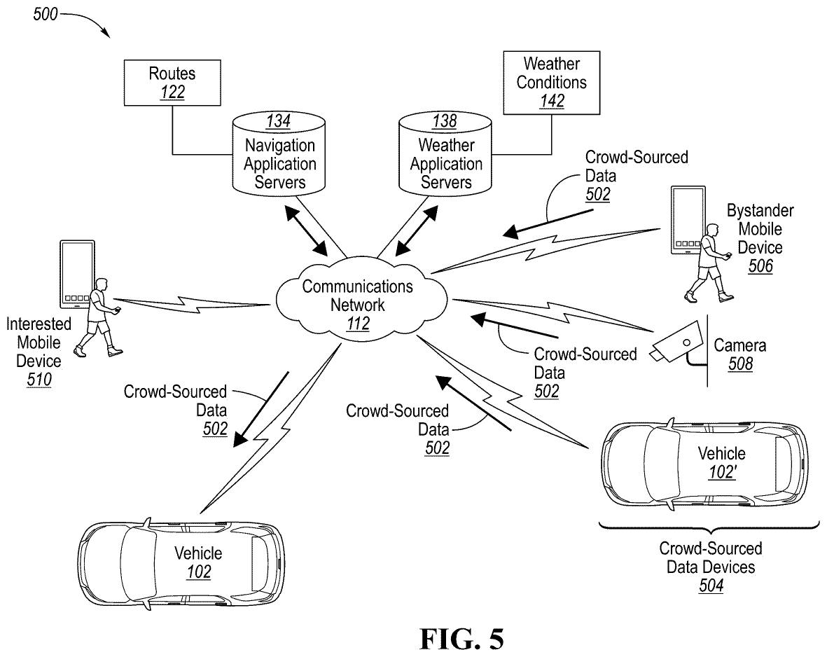

In still another example, the navigation engine 140 may allow the user to utilize crowd-sourced data 502 to corroborate and/or augment the routes 122. Aspects of the use of crowd-sourced data 502 are discussed below with respect to FIG. 5. Regardless of which approach is used, after operation 318 the process 300 ends.

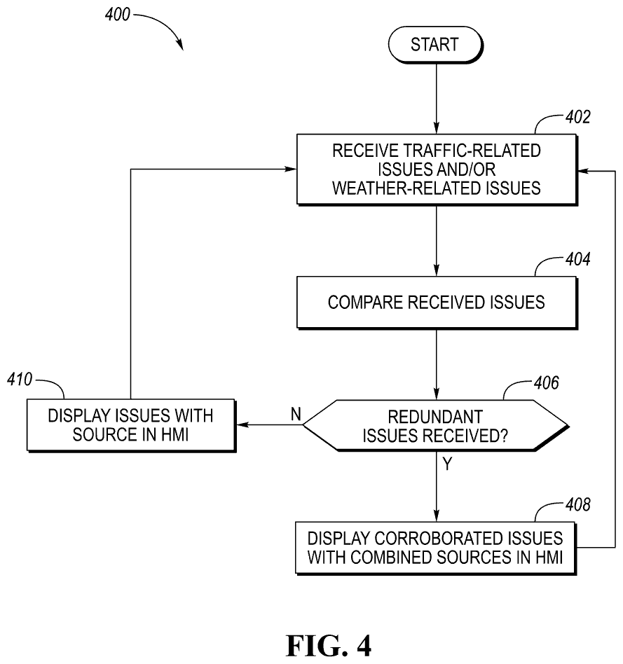

FIG. 4 illustrates an example process 400 for using the navigation engine 140 in communication with a plurality of navigation applications 132 and/or weather applications 136 to provide notifications of traffic-related route conditions 202 and/or weather-related route conditions 204.

At operation 402, the navigation engine 140 utilizes the one or more mobile devices 110 to receive traffic-related route conditions 202 and/or weather-related route conditions 204. In an example, similar to as discussed with respect to operations 302 and 308-310, the navigation engine 140 may utilize the one or more mobile devices 110 to access a plurality of navigation applications 132 and/or weather applications 136. As a variation, one or more of the navigation applications 132 and/or weather applications 136 may be executed by the vehicle 102 (e.g., via one or more of the controllers 104, such as the controllers providing the connectivity interfaces 146 or another controller 104). These traffic-related route conditions 202 and/or weather-related route conditions 204 may be received initially, e.g., with the routes 122 and/or weather conditions 142. In another example, the traffic-related route conditions 202 and/or weather-related route conditions 204 may be received over time after the vehicle 102 has begun to proceed along the route 122. In either case, the navigation engine 140 may receive, from the plurality of navigation applications 132, zero or more traffic-related route conditions 202. The navigation engine 140 may also receive, from the one or more weather applications 136, zero or more weather-related route conditions 204.

At operation 404, the navigation engine 140 compares the traffic-related route conditions 202 and/or the weather-related route conditions 204. In an example, the navigation engine 140 may provide the routes 122 to a machine learning model along with a prompt asking if the route conditions include the same or different traffic-related route conditions 202 and/or weather-related route conditions 204. In another example, the prompt may ask whether the weather-related route conditions 204 appear related to the traffic-related route conditions 202. The results may be returned to the navigation engine 140 from the model.

At operation 406, the navigation engine 140 determines whether redundant issues are received. For example, if the routes 122 are indicated by the model as including the same or related traffic-related route conditions 202 and/or weather-related route conditions 204, control passes to operation 408 to combine and display those issues as a combined traffic-related route condition 202 or weather-related route condition 204. Otherwise, control passes to operation 410 to display the uncorrelated traffic-related route conditions 202 and/or weather-related route conditions 204 separately.

At operation 408, the navigation engine 140 displays the combined traffic-related route conditions 202 and/or weather-related route conditions 204 to the HMI 120. Examples of such combined issues are shown in FIGS. 2D and 2E. After operation 408, control returns to operation 402.

At operation 410, the navigation engine 140 separately displays the uncorrelated traffic-related route conditions 202 and/or weather-related route conditions 204. After operation 410, control returns to operation 402.

Variations on the processes 300 and 400 are possible. In an example, while traversing the route 122 the navigation applications 132 and/or the weather applications 136 may continually provide the current location of the vehicle 102 (e.g., as determined by the GNSS controller 108). Based on the updated location, the navigation engine 140 may receive updated routes 122 and/or weather conditions 142 from the navigation application servers 134 and/or the weather application servers 138. This flow of information may be used to provide updates to the route 122 and/or updates to the traffic-related route condition 202 and weather-related route condition 204 as the vehicle progresses to the destination 126.

FIG. 5 shows an illustrative example 500 of the vehicle 102 utilizing crowd-sourced data 502 from crowd-sourced data devices 504 to corroborate and/or augment the operation of the navigation engine 140. In the example 500, the vehicle 102 may utilize crowd-sourced data 502 collected from one or more other vehicles 102′, bystander mobile devices 506, and/or cameras 508. This data may be used as an additional data source, in addition to the use of the navigation applications 132 and the weather applications 136.

The crowd-sourced data 502 refers to data captured by the crowd-sourced data devices 504 that may be used to aid the navigation engine 140 in determining the route 122. The crowd-sourced data 502 may include data such as images, video, audio, temperature data, humidity data, etc.

In an example, one or more other vehicles 102′ may utilize their sensors 106 to provide crowd-sourced data 502 about the roadways that may be traversed by the vehicle 102. In another example, one or more bystander mobile devices 506 may be used to capture images, video, and/or audio that may be provided crowd-sourced data 502 to the vehicle 102. In yet another example, cameras 508 such as highway traffic cameras or vehicle presence detection cameras may be used as sources of fixed-position crowd-sourced data 502. In many examples, the vehicles 102, bystander mobile devices 506, and/or the cameras 508 may be required to have an owner or operator opt into the sharing of the crowd-sourced data 502.

The vehicle 102 and the crowd-sourced data devices 504 may exchange messages over the communications network 112 and/or through V2X communication. For instance, the vehicle 102 may send a message requesting for crowd-sourced data devices 504 within range and/or along the routes 122 between the origin 124 and the destination 126 to provide crowd-sourced data 502 to the vehicle 102. This message may be sent as a V2X broadcast in one example, or may be sent to the communications networks 112 which may, in turn, forward the message to any opted-in crowd-sourced data devices 504 connected to the same cellular tower as the vehicle 102.

The crowd-sourced data 502 may be used to aid the vehicle 102 with selection of a preferred route 122. This may be useful in cases where there are inconsistencies in the routes 122 provided from the different navigation applications 132. This may also be useful for areas in which there is limited map, weather, or traffic information available to the navigation engine 140 from the navigation application servers 134 and/or weather application servers 138. For instance, a camera 508 along the road may visually show rain or snow for an area that is not covered by a weather forecast.

The navigation engine 140 may use the crowd-sourced data 502 as an additional source to update and confirm the route 122 and weather conditions 142 as the vehicle 102 travels to the destination 126. Thus, the route 122 may be updated in response to updated routes 122 and/or weather conditions 142 as provided by the navigation applications 132, weather applications 136, and/or crowd-sourced data 502.

The navigation engine 140 may also be configured to generate and communicate status messages. The status messages may be provided in response to predetermined events, such as a change in the timing to reach the destination 126 or a delay in travel. In an example, the status messages may be provided to an interested remote device 510 such as a family member's handheld device, another vehicle 102′, or to a jobsite dispatcher. The status message may be sent via various communications protocols (such as over the communications networks 112, via V2X, etc.) and may take the form of an email, text message, or the like. The destination 126 may identify the recipient of the status message by email address or mobile phone number, for instance. As one possible use case, a jobsite dispatcher may be notified when a package of materials reaches the destination 126 and the vehicle 102 is available for additional work. Alternatively, or in addition, a worker or business may receive the status message shortly before the vehicle 102 reaches the destination 126 as a reminder to be prepared to accept the package of materials. In some possible approaches, the vehicle 102 is an autonomous vehicle 102 configured to operate in an autonomous (e.g., driverless) mode, a partially autonomous mode, and/or a non-autonomous mode.

In further examples the navigation engine 140 may perform an optimization using the routing preferences 128 and weather preferences 130 to adjust wait times for a given weather scenario (e.g. waiting in an unsheltered area when it is cold and snowy or hot may be less preferred than a slowdown where it is sunny and mild).

As an incentive for owners and/or operators of the crowd-sourced data devices 504 to collect the crowd-sourced data 502, the owner and/or operator of the vehicle 102 may utilize the navigation engine 140 to offer a reward for route 122 investigation and collection of real-time information or even alternative route 122 suggestions. These rewards may be combined to incentivize the owners or operators of the crowd-sourced data devices 504 to travel along a proposed navigation route 122 to capture crowd-sourced data 502 to receive the reward.

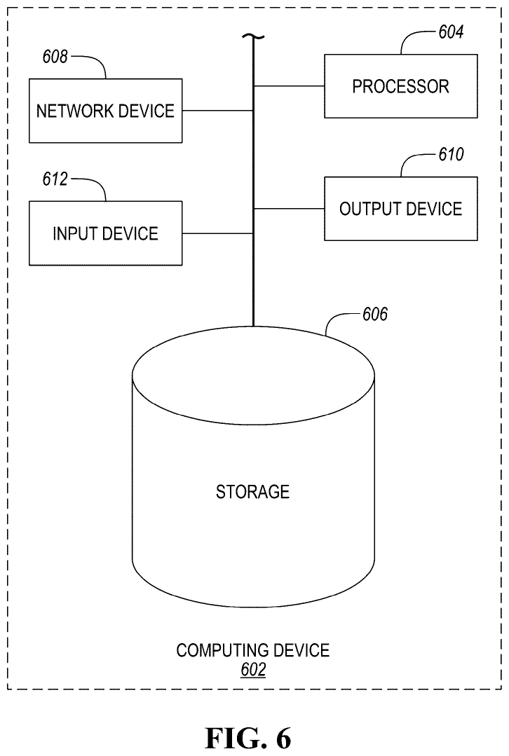

FIG. 6 illustrates an example computing device 602 for use in implementing the navigation system 100 for vehicles 102. Referring to FIG. 6, and with reference to FIGS. 1-5, the vehicles 102, controllers 104, TCU 114, communications network 112, sensors 106, GNSS controller 108, HMI 120, mobile devices 110, navigation application servers 134, weather application servers 138, and navigation engine 140, are examples of such computing devices 602. Computing devices 602 generally include computer-executable instructions, such as those of the navigation engine 140, navigation application server 134, weather application server 138, as well as process 300, where the instructions may be executable by one or more computing devices 602. Computer-executable instructions may be compiled or interpreted from computer programs created using a variety of programming languages and/or technologies, including, without limitation, and either alone or in combination, Java™, C, C++, C #, Visual Basic, JavaScript, Python, JavaScript, Perl, etc. In general, a processor (e.g., a microprocessor) receives instructions, e.g., from a memory, a computer-readable medium, etc., and executes these instructions, thereby performing one or more processes, including one or more of the processes described herein (e.g., the process 300, the process 400). Such instructions and other data, such as the destination 126, the routing preferences 128, weather preferences 130 may be stored and transmitted using a variety of computer-readable media.

As shown, the computing device 602 may include a processor 604 that is operatively connected to a storage 606, a network device 608, an output device 610, and an input device 612. It should be noted that this is merely an example, and computing devices 602 with more, fewer, or different components may be used.

The processor 604 may include one or more integrated circuits that implement the functionality of a central processing unit (CPU) and/or graphics processing unit (GPU). In some examples, the processors 604 are a system on a chip (SoC) that integrates the functionality of the CPU and GPU. The SoC may optionally include other components such as, for example, the storage 606 and the network device 608 into a single integrated device. In other examples, the CPU and GPU are connected to each other via a peripheral connection device such as Peripheral Component Interconnect (PCI) express or another suitable peripheral data connection. In one example, the CPU is a commercially available central processing device that implements an instruction set such as one of the x86, ARM, Power, or Microprocessor without Interlocked Pipeline Stages (MIPS) instruction set families.

Regardless of the specifics, during operation the processor 604 executes stored program instructions that are retrieved from the storage 606. The stored program instructions, accordingly, include software that controls the operation of the processors 604 to perform the operations described herein. The storage 606 may include both non-volatile memory and volatile memory devices. The non-volatile memory includes solid-state memories, such as Not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the optimized route navigation system 100.

The GPU may include hardware and software for display of at least two-dimensional (2D) and optionally three-dimensional (3D) graphics to an output device 610. The output device 610 may include a graphical or visual display device, such as an electronic display screen, projector, printer, or any other suitable device that reproduces a graphical display. As another example, the output device 610 may include an audio device, such as a loudspeaker or headphone. As yet a further example, the output device 610 may include a tactile device, such as a mechanically raiseable device that may, in an example, be configured to display braille or another physical output that may be touched to provide information to an occupant.

The input device 612 may include any of various devices that enable the computing device 602 to receive control input from occupants. Examples of suitable input devices 612 that receive human interface inputs may include keyboards, mice, trackballs, touchscreens, microphones, graphics tablets, and the like.

The network devices 608 may each include any of various devices that enable the described components to send and/or receive data from external devices over networks. Examples of suitable network devices 608 include an Ethernet interface, a Wi-Fi transceiver, a cellular transceiver, or the BLUETOOTH or BLE transceiver, or other network adapter or peripheral interconnection device that receives data from another computer or external data storage device, which can be useful for receiving large sets of data in an efficient manner.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A vehicle for determining optimal routes, comprising:
one or more controllers providing at least one connectivity interface, the at least one connectivity interface being configured to connect with a plurality of navigation applications executed by the one or more controllers and/or by one or more mobile devices; and
a navigation engine executed by at least one of the one or more controllers, the navigation engine configured to:
receive a plurality of routes, from an origin to a destination, from each of the plurality of navigation applications, including to identify a recommended route from each of the plurality of navigation applications to define a set of recommended routes,
aggregate the recommended routes to determine discrepancies between the recommended routes,
responsive to the recommended routes being in agreement, utilize the recommended routes as an optimized route for the vehicle, and
responsive to the recommended routes not being in agreement, illustrate the discrepancies in a human-machine interface (HMI) of the vehicle.

2. The vehicle of claim 1, wherein the at least one connectivity interface includes a plurality of connectivity interfaces, and the one or more controllers providing the plurality of connectivity interfaces includes at least two of a telematics control unit (TCU), a vehicle entertainment controller, and a keyless entry controller.

3. The vehicle of claim 1, wherein:
a first navigation application of the plurality of navigation applications is executed by a first mobile device of the one or more mobile devices, and
a second navigation application of the plurality of navigation applications is executed by a second mobile device of the one or more mobile devices.

4. The vehicle of claim 1, wherein the plurality of navigation applications includes multiple navigation applications executed by one of the one or more mobile devices.

5. The vehicle of claim 1, wherein:
a first navigation application of the plurality of navigation applications is executed by the one or more controllers, and
a second navigation application of the plurality of navigation applications is executed by a first mobile device of the one or more mobile devices.

6. The vehicle of claim 1, wherein the navigation engine is further configured to:
retrieve weather conditions associated with the plurality of routes using one or more weather applications executed by the one or more mobile devices; and
optimize the recommended routes based on user-defined weather preferences and the retrieved weather conditions.

7. The vehicle of claim 1, wherein the navigation engine determines the recommended routes as being in agreement responsive to all of the recommended routes having a variation within a predefined threshold of time.

8. The vehicle of claim 1, wherein the navigation engine determines the recommended routes as being in agreement responsive to a majority of the recommended routes being in agreement.

9. The vehicle of claim 1, wherein the navigation engine is further configured to:
receive a first traffic-related route condition from a first navigation application of the plurality of navigation applications;
receive a second traffic-related route condition from a second navigation application of the plurality of navigation applications;
utilize a machine-learning model to determine whether the first and second traffic-related route conditions corroborate an issue along the optimized route;
responsive to the first and second traffic-related route conditions indicating the corroborated issue, illustrate the corroborated issue in the HMI as being identified by the first and second navigation applications; and
otherwise, illustrate the first and second traffic-related route conditions as separate issues in the HMI.

10. The vehicle of claim 9, wherein the navigation engine is further configured to:
send a message to listening crowd-sourced data devices to request crowd-sourced data; and
receive the crowd-sourced data from the crowd-sourced data devices to corroborate and/or augment the traffic-related route conditions from the navigation applications.

11. A method for determining optimal routes for a vehicle, comprising:
receiving a plurality of routes, from an origin to a destination, from each of a plurality of navigation applications executed by the one or more controllers and/or by one or more mobile devices in communication with the vehicle over at least one connectivity interface;
identifying a recommended route from each of the plurality of navigation applications to define a set of recommended routes;
aggregating the recommended routes to determine discrepancies between the recommended routes;
responsive to the recommended routes being in agreement, utilizing the recommended routes as an optimized route for the vehicle; and
responsive to the recommended routes not being in agreement, illustrating the discrepancies in an HMI of the vehicle.

12. The method of claim 11, further comprising:
providing, a plurality of connectivity interfaces using at least two of a TCU of the vehicle, a vehicle entertainment controller of the vehicle, and a keyless entry controller of the vehicle,
wherein a first navigation application of the plurality of navigation applications is executed by a first mobile device of the one or more mobile devices, and
wherein a second navigation application of the plurality of navigation applications is executed by a second mobile device of the one or more mobile devices.

13. The method of claim 11, further comprising:
retrieving weather conditions associated with the plurality of routes using one or more weather applications executed by the one or more mobile devices; and
optimizing the recommended routes based on user-defined weather preferences and the retrieved weather conditions.

14. The method of claim 11, further comprising one of:
determining the recommended routes as being in agreement responsive to all of the recommended routes having a variation within a predefined threshold of time; or
determining the recommended routes as being in agreement responsive to a majority of the recommended routes being in agreement.

15. The method of claim 10, further comprising:
receiving a first traffic-related route condition from a first navigation application of the plurality of navigation applications;
receiving a second traffic-related route condition from a second navigation application of the plurality of navigation applications;
utilizing a machine-learning model to determine whether the first and second traffic-related route conditions corroborate an issue along the optimized route;
responsive to the first and second traffic-related route conditions indicating the corroborated issue, illustrating the corroborated issue in the HMI as being identified by the first and second navigation applications; and
otherwise, illustrating the first and second traffic-related route conditions as separate issues in the HMI.

16. The method of claim 15, further comprising:
sending a message to listening crowd-sourced data devices to request crowd-sourced data; and
receiving the crowd-sourced data from the crowd-sourced data devices to corroborate and/or augment the traffic-related route conditions from the navigation applications.

17. A non-transitory computer-readable medium comprising instructions for determining optimal routes for a vehicle that, when executed by one or more controllers of the vehicle, cause the vehicle to perform operations including to:
provide a plurality of connectivity interfaces using at least two of a TCU of the vehicle, a vehicle entertainment controller of the vehicle, and a keyless entry controller of the vehicle,
receive a plurality of routes, from an origin to a destination, from each of a plurality of navigation applications executed by the one or more controllers and/or by a plurality of mobile devices in communication with the vehicle over the plurality of connectivity interfaces;
identify a recommended route from each of the plurality of navigation applications to define a set of recommended routes;
aggregate the recommended routes to determine discrepancies between the recommended routes;
responsive to the recommended routes being in agreement, utilize the recommended routes as an optimized route for the vehicle; and
responsive to the recommended routes not being in agreement, illustrate the discrepancies in a HMI of the vehicle.

18. The non-transitory computer-readable medium of claim 17, further comprising instructions that, when executed by the one or more controllers of the vehicle, cause the vehicle to perform operations including to:
retrieve weather conditions associated with the plurality of routes using one or more weather applications executed by the plurality of mobile devices; and
optimize the recommended routes based on user-defined weather preferences and the retrieved weather conditions.

19. The non-transitory computer-readable medium of claim 17, further comprising instructions that, when executed by the one or more controllers of the vehicle, cause the vehicle to perform operations including to determine the recommended routes as being in agreement responsive to at least a majority of the recommended routes being in agreement.

20. The non-transitory computer-readable medium of claim 17, further comprising instructions that, when executed by the one or more controllers of the vehicle, cause the vehicle to perform operations including to:
receive a first traffic-related route condition from a first navigation application of the plurality of navigation applications;
receive a second traffic-related route condition from a second navigation application of the plurality of navigation applications;
utilize a machine-learning model to determine whether the first and second traffic-related route conditions corroborate an issue along the optimized route;
responsive to the first and second traffic-related route conditions indicating the corroborated issue, illustrate the corroborated issue in the HMI as being identified by the first and second navigation applications; and
otherwise, illustrate the first and second traffic-related route conditions as separate issues in the HMI.

21. The non-transitory computer-readable medium of claim 20, further comprising instructions that, when executed by the one or more controllers of the vehicle, cause the vehicle to perform operations including to:
send a message to listening crowd-sourced data devices to request crowd-sourced data; and
receive the crowd-sourced data from the crowd-sourced data devices to corroborate and/or augment the traffic-related route conditions from the navigation applications.
